(19) United States
(12) Patent Application Publication
(10) Pub. No.: US 2016/0150874 A1
(43) Pub. Date: Jun. 2, 2016

(54) CONSTRUCTIVE DISPOSITION APPLIED TO TOOTHBRUSH CONJUGATED TO DENTAL FLOSS

(71) Applicant: Romulo Rocha Silva, Porto Velho - Rondonia (BR)

(72) Inventor: Romulo Rocha Silva, Porto Velho - Rondonia (BR)

(21) Appl. No.: 14/574,867

(22) Filed: Dec. 18, 2014

(30) Foreign Application Priority Data
Dec. 2, 2014 (BR) 2020140301637

(51) Int. Cl. A46B 15/00; A61C 15/04

(52) U.S. Cl. CPC A46B 15/0069; A61C 15/043

(57) ABSTRACT

A constructive disposition applied to a toothbrush conjugated to dental floss is described herein. In some embodiments, the toothbrush includes a main body formed by a brushing rod and a cable cover, with said brushing rod being provided on its upper end with a toothbrush head provided with several bristles, positioned on a base below which there is a support followed by a strap handle, which is provided internally with a cavity housing a coil that lodges a dental floss roll, having its filament inserted into a channel provided with a cutting blade, wherein from said handle strap in the lower section projects an articulated cover, with the cable cover defining in its upper section multiple vent holes.

### CROSS-REFERENCE TO RELATED APPLICATION

This application claims priority to Brazil Patent Application No. BR2020140301637, entitled “CONTRUSCTIVE DISPOSITION APPLIED TO TOOTHBRUSH CONJUGATED TO DENTAL FLOSS”, filed Dec. 2, 2014, which application is incorporated in its entirety by reference.

### FIELD OF THE INVENTION

Refers the present patent for utility model to the “CONSTRUCTIVE DISPOSITION APPLIED TO TOOTHBRUSH CONJUGATED TO DENTAL FLOSS”, which was developed in order to facilitate the oral hygiene of the users in a practical, comfortable and hygienic way, through a multifunctional toothbrush, provided with a compartment for floss packaging, this arranged in the form of refills, which enables a complete dental cleaning by brushing and the application of dental floss, thus facilitating the user routine, who spends most of the day in work situations or outside, promoting an optimization of objects in the act of cleaning and consequently reducing the volume of discarded materials, dealing with an evolutionary nature solution whose practical obtained result reports for a differentiated and effective condition of use, for better convenience of users.

### BACKGROUND OF THE INVENTION

Throughout history, human beings have always made use of creativity to remove bits of food between teeth.

The first toothbrush was used in China in 1498, and was made with pig hair. Later, the pig hair was eventually replaced by horse hair.

The oldest toothbrush of Europe arose 300 years ago, made with bone and was discovered during archaeological excavations in an old municipal hospital in Minden, Germany.

In 1938, DuPont developed the nylon bristles, used nowadays.

The fall and diseases of the teeth can be caused by bacterial action resulting from plaque formation around the teeth and the capture of food particles between the teeth and the gaps between them. The removal of plaque and captured food particles reduces the incidence of cavities, gingivitis, and mouth odors as well as generally improving the dental hygiene. Conventional brushing has proven to be inadequate to remove all stuck food particles and plaque. To supplement brushing, dental floss and tape has been recommended. The expression “dental floss”, as used herein, is defined to include both dental flosses, dental tapes, and all similar products.

To improve the efficiency and convenience of dental flosses using.

The inventor of dental floss, a product that along with the toothbrush is essential for oral health, was the dentist of New Orleans, Levi Spear Parmly, in 1815. He began to recommend to his patients to use his own dental floss, made of silk.

However, Levi Parmly developed dental floss and recommended it only to his patients, at small scales. The wide production of dental floss began with the Codman & Shurtleft company in 1882; and in 1898, Johnson & Johnson started to have the first patent of dental floss.

Until then, dental floss was made from silk, unlike the wire we know today. The nylon thread was developed by Charles C. Bass, who improved it, increasing its elasticity and especially its resistance. Dental floss is so important for oral hygiene because there are certain food residue and bacterial plaque between teeth that the brush cannot eliminate, giving to dental floss this function.

There are in the market dental flosses made of nylon, waxed or not, with a variety of flavors. Because this type of wire is composed of many nylon fibers, it can sometimes tear or shred, especially if the teeth are too close together. Although more expensive, the only filament wire (PTFE) slides easily between teeth, even with little space, and does not break.

If used properly, the two types of wire remove bacterial plaque and food residues. Often, after brushing your teeth, you are still surprised by an unpleasant taste in the mouth. This is because inevitably there are leftover food residue and plaque between teeth that the brush bristles could not reach and eliminate.

In addition to this untimely taste, there are some serious additional risks: persistent bad breath, tooth decay, and gum disease.

This is precisely because it is in the region between the teeth (place of difficult access for cleaning) that there is a strong tendency to form cavities and gum disease in a more severe form.

It is the dental floss that reaches where the toothbrush cannot and remove the last residues of food that stay between the teeth, both in front and in back. It also removes bacterial plaque coming out of the teeth being gripped in dental floss.

Finally a good oral hygiene is one of the most important steps you can take to keep your teeth and gums in order. Healthy teeth not only contribute to you to look good, but are also important for you to speak well and properly chew food. Maintaining a healthy mouth is important for the general well-being.

Preventive daily care such as proper brushing and proper flossing help to prevent dental problems from becoming more serious. We must keep in mind that prevention is the most economical way, less painful, and less worrisome to take care of oral health and that by taking preventative measures, we avoid dealing with problems that become severe. There are some very simple steps that each of us can take to greatly decrease the risk of developing cavities, gingivitis and other oral problems.

Given this situation we must keep in mind that many places where meals are served do not have dental floss for customers or wherever it can be found, it has its supporters set inside the toilet, which enables contamination of all the wires even packaged inside the support, because bacteria disposed in the air penetrates easily through hole through which dental floss is removed.

### SUMMARY

It is the aim of this application to provide the market with the multifunctional brush, to assist and streamline the oral hygiene, so after long trial period and studies, the inventor has developed the “CONSTRUCTIVE DISPOSITION APPLIED TO TOOTHBRUSH CONJUGATED TO DENTAL FLOSS” comprised of a main body formed by brushing rod and cable cover, and said brushing rod is provided in its upper end with a brushing head with several bristles, positioned on a base below which there is a support followed by a strap handle, this provided internally with a cavity housing a coil that lodges a dental floss roll, whose filament is inserted into the channel provided with cutting blade, wherein said handle strap in the lower section projects an articulated cover, and the cable cover in its upper section is provided with vent holes.

### BRIEF DESCRIPTION OF THE DRAWINGS

In order to obtain a full understanding of what was developed, illustrative drawings are added, which are made numeral reference to in conjunction with a detailed description that follows, where:

FIG. 1 shows a side view of a brush in a closed configuration in accordance with some embodiments.

FIG. 2 shows a side view of the brush in a position of use for brushing, in accordance with some embodiments.

FIG. 3 shows a partial cutaway side view of the brush in a position of flossing, in accordance with some embodiments.

FIG. 4 shows a top view of a cable cover, in accordance with some embodiments.

FIG. 5 shows a side view of the cable cover, in accordance with some embodiments.

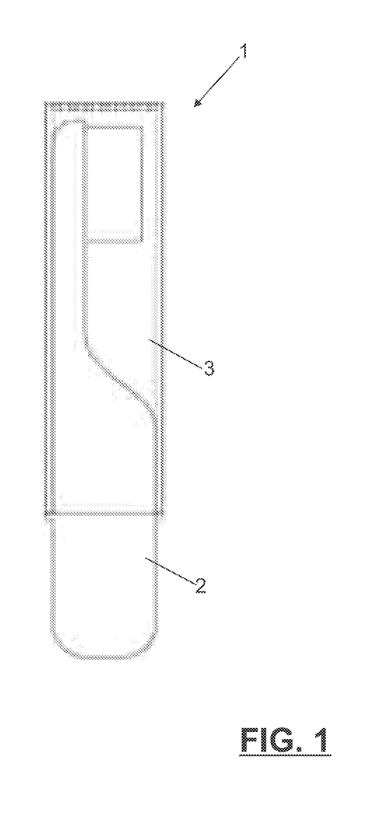

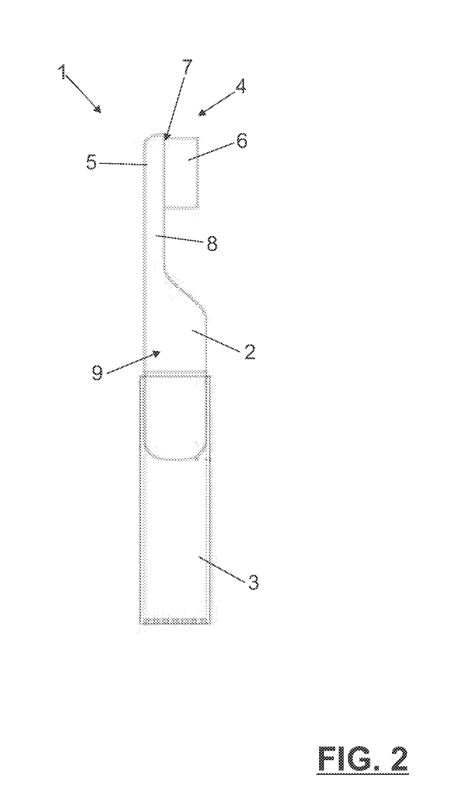

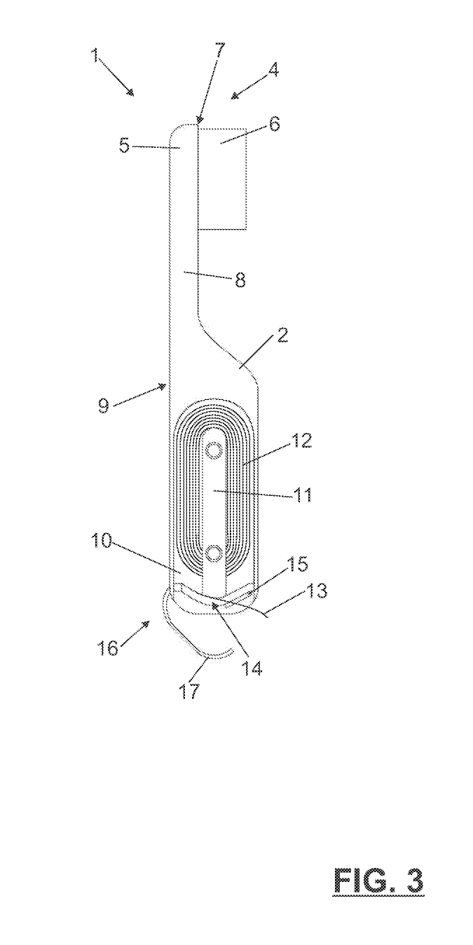

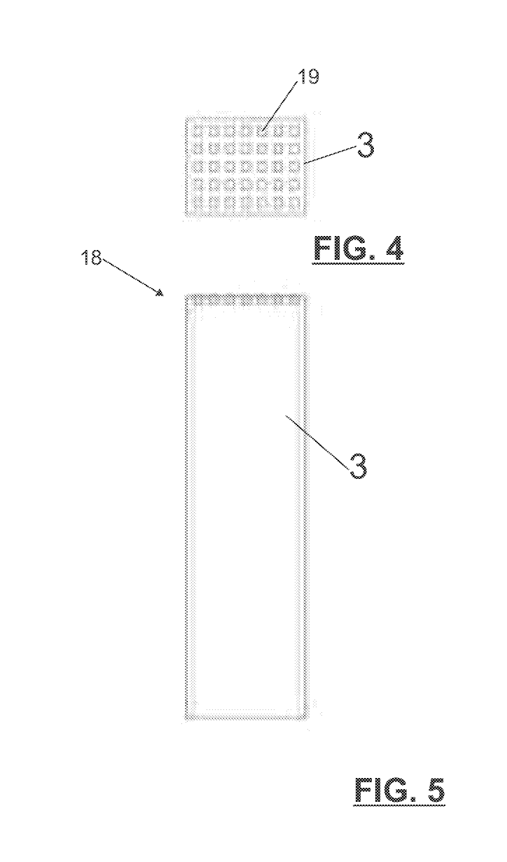

### DETAILED DESCRIPTION

As shown in figures and in its details “CONSTRUCTIVE DISPOSITION APPLIED TO TOOTHBRUSH CONJUGATED TO DENTAL FLOSS” some embodiments of the invention include a main body (1) formed by brushing rod (2) and cable cover (3), being said brushing rod (2) provided on its upper end (4) with a toothbrush head (5) provided with several bristles (6), positioned on a base (7) below which there is a support (8) followed by a strap handle (9), in some embodiments, this provided internally with a cavity (10) housing a coil (11) that houses dental floss roll (12), having its filament (13) inserted into a channel (14) provided with a cutting blade (15), wherein said handle strap (9) in the lower section (16) projects an articulated cover (17), with cable cover (3) in its upper section (18) provided with vent holes (19).

Given the described it is possible to realize that at least some embodiments of the “CONSTRUCTIVE DISPOSITION APPLIED TO TOOTHBRUSH CONJUGATED TO DENTAL FLOSS” bring considerable advantages for users as such embodiments provide a complete oral hygiene object according to odontological standards, where is present a toothbrush and floss which makes it easy cleaning teeth, with the brush bristles protected by the cable cover that is removed for brushing, coupled to the handle strap, so that after brushing it is again positioned so to protect the bristles, and the user open the articulated lid and remove dental floss to the desired extent that is cut by the blade, besides the fact that the object is compact and easy packaging in bags.

For meeting all the requirements that define the utility model patent, as combined and modified known elements, giving them innovative general appearance and capable of industrialization, and modifications can be made without departing from the spirit and scope of the invention, are the following their claims.

What is claimed is:

1. A toothbrush, comprising:
a main body comprising a brushing rod and a toothbrush cover, the toothbrush cover comprising a distal end and a proximal end, wherein the brushing rod comprises:
a toothbrush head comprising bristles;
a handle comprising an upper section and a lower section; and
a support extending between the toothbrush head and the upper section of the handle,
wherein the handle defines an internal cavity housing dental floss,
wherein a filament of the dental floss is inserted into a channel in the toothbrush,
wherein the toothbrush comprises a cutting blade configured to cut the filament,
wherein the handle comprises an articulated cover disposed in the lower section of the handle, the articulated cover configured to selectively open and close to provide access to and to cover the channel,
wherein the toothbrush cover comprises multiple vent holes disposed at the distal end, and
wherein the toothbrush cover is configured to protect the toothbrush head by being configured to selectively and detachably couple the proximal end to at least a portion of the upper section of the handle such that the toothbrush cover encloses the bristles when the main body and toothbrush cover are in a closed configuration and to selectively and detachably couple the proximal end to at least a portion of the lower section of the handle such that the bristles are exposed when the main body and toothbrush cover are in a position for brushing.

2. A toothbrush comprising:
a brushing rod having:
a first end with a toothbrush head comprising multiple bristles;
a second end comprising a handle with an upper section and a lower section, the handle defining an internal cavity; and
a support extending between the toothbrush head and the upper section of the handle; and
a toothbrush cover comprising a distal end and a proximal end, the toothbrush cover being configured to protect the toothbrush head by selectively and detachably coupling the proximal end to at least a portion of the upper section of the handle such that the toothbrush cover encloses the bristles when the toothbrush is in a closed configuration, the toothbrush cover further being configured to selectively and detachably couple the proximal end to at least a portion of the lower section of the handle such that the bristles are exposed when the toothbrush is in a position for brushing,
wherein a length of dental floss is disposed within the internal cavity of the handle.

3. The toothbrush of claim 2, further comprising an articulated cover on the handle, the articulated cover being configured to selectively open and to close to respectively provide access to and cover a portion of the dental floss.

4. The toothbrush of claim 2, wherein the toothbrush cover defines vent holes at the distal end of the toothbrush cover.

5. The toothbrush of claim 2, further comprising a cutting blade on the handle, wherein the cutting blade is configured to cut the dental floss.

6. The toothbrush of claim 2, further comprising a channel in the handle that is configured to receive a filament of the dental floss and dispense a portion of the dental floss from the toothbrush.

7. The toothbrush of claim 2, further comprising two floss supports disposed within the internal cavity of the handle, the two floss supports arranged substantially perpendicular to a longitudinal axis of the brushing rod and configured to accept a winding of the dental floss.

8. A multifunction toothbrush comprising:
a toothbrush head disposed on an upper end of a brushing rod;
a handle disposed on a lower end of the brushing rod, the handle comprising an upper section and a lower section;
an internal cavity disposed in the lower section of the handle, the internal cavity housing dental floss;
an articulated cover disposed at the lower section of the handle, the articulated cover being configured to selectively open and close to provide access to the dental floss; and
a toothbrush cover comprising a distal end and a proximal end,
wherein the toothbrush cover is configured to protect the toothbrush head by being configured to selectively and detachably couple the proximal end to at least a portion of the upper section of the handle such that the toothbrush head is enclosed when the toothbrush is in a closed configuration,
wherein the toothbrush cover is configured to selectively and detachably couple the proximal end to at least a portion of the lower section of the handle such that the toothbrush head is exposed when the toothbrush is in a position for brushing, and
wherein the toothbrush cover is configured to be selectively and detachably removed such that the articulated cover is accessible when the toothbrush is in a position for flossing.

9. The multifunction toothbrush of claim 8, wherein the toothbrush cover comprises a planar surface at the distal end, the planar surface being oriented to be substantially perpendicular to a longitudinal axis of the toothbrush.

10. The multifunction toothbrush of claim 9, wherein the planar surface comprises multiple vent holes.

11. The multifunction toothbrush of claim 8, further comprising two floss supports spaced apart from each other within the internal cavity of the handle, the dental floss being wrapped around the two floss supports.

12. The multifunction toothbrush of claim 8, wherein the toothbrush cover is configured to prevent access to the articulated cover by detachably coupling the proximal end to at least a portion of the handle such that the articulated cover is covered at least in part when the toothbrush is in a position for brushing.

13. The multifunction toothbrush of claim 8, wherein the handle comprises a cutting blade configured to cut the dental floss.

14. The multifunction toothbrush of claim 8, further comprising a channel in the handle that is configured to receive a filament of the dental floss and dispense a portion of the dental floss from the toothbrush.

15. The multifunction toothbrush of claim 8, wherein the toothbrush head comprises bristles.

16. The multifunction toothbrush of claim 8, wherein the toothbrush is configured to receive refills of dental floss.

17. The multifunction toothbrush of claim 8, wherein the dental floss comprises one or more of dental tape, waxed floss, nylon floss, and PTFE floss.
